(19) United States
(12) Patent Application Publication
(10) Pub. No.: US 2026/0296211 A1
(43) Pub. Date: Oct. 1, 2026

(54) DC-DC CONVERTER MOUNTING STRUCTURE

(71) Applicants: Hino Motors, Ltd., Tokyo (JP); TOYOTA JIDOSHA KABUSHIKI KAISHA, Toyota-shi (JP)

(72) Inventors: Akinori OKO, Tokyo (JP); Gaku HASEGAWA, Tokyo (JP)

(73) Assignees: Hino Motors, Ltd., Tokyo (JP); TOYOTA JIDOSHA KABUSHIKI KAISHA, Toyota-sh (JP)

(21) Appl. No.: 19/557,961

(22) Filed: Mar. 5, 2026

(30) Foreign Application Priority Data
Mar. 31, 2025 (JP) 2025-058416

(51) Int. Cl. B60L 15/00; B62D 21/02

(52) U.S. Cl. CPC B60L 15/007; B62D 21/02; B60L 2210/10

(57) ABSTRACT

A DC-DC converter mounting structure is for mounting a DC-DC converter below a cross member in a vehicle having a pair of side rails arranged in a vehicle width direction and a cross member provided to be bridged between the pair of side rails. The DC-DC converter mounting structure includes a holding member that is disposed below the cross member in a state of holding the DC-DC converter, and a bracket for fixing the holding member to the pair of side rails and/or the cross member.

### CROSS-REFERENCE TO RELATED APPLICATIONS

This application is based upon and claims the benefit of priority from Japanese Patent Application No. 2025-058416, filed on Mar. 31, 2025, the entire contents of which are incorporated herein by reference.

### TECHNICAL FIELD

The present disclosure relates to a DC-DC converter mounting structure.

### BACKGROUND

Japanese Unexamined Patent Publication No. 2021-104760 describes a mounting structure for mounting an electronic device on a vehicle. The vehicle includes a pair of side members that extend in a longitudinal direction and are spaced apart in a vehicle width direction, and a first cross member and a second cross member that connect the pair of side members to each other. The first cross member is located in front of the second cross member. The electronic device is disposed between the first cross member and the second cross member.

### SUMMARY

Generally, since an electrified vehicle has a plurality of electronic devices including a DC-DC converter, and a plurality of wire harnesses that electrically connect the plurality of electronic devices to each other, it is necessary to mount the DC-DC converter while effectively utilizing space. In addition, due to requirements for mounting vibration requirements (such as G-resistance performance), it has been difficult to simplify the structure when considering a structural design that minimizes damage to the DC-DC converter as much as possible.

Therefore, an object of the present disclosure is to provide a DC-DC converter mounting structure that can mount a DC-DC converter in an electrified vehicle while effectively utilizing space, and whose structure can be simplified.

A DC-DC converter mounting structure according to the present disclosure is [1] “a DC-DC converter mounting structure for mounting a DC-DC converter below a cross member in an electrified vehicle having a pair of side rails arranged in a vehicle width direction and the cross member provided to be bridged between the pair of side rails, the DC-DC converter mounting structure including: a holding member that is disposed below the cross member in a state of holding the DC-DC converter; and a bracket for fixing the holding member to the side rails and/or the cross member.”

In this DC-DC converter mounting structure, a holding member in a state of holding a DC-DC converter is disposed below a cross member, and the holding member is fixed to the side rails and/or the cross member by a bracket. This allows the DC-DC converter to be mounted below the cross member. Thus, according to this DC-DC converter mounting structure, the DC-DC converter can be mounted by effectively utilizing the space below the cross member. In addition, in this DC-DC converter mounting structure, the DC-DC converter is disposed at a portion where the cross member is installed on the pair of side rails, which have relatively high rigidity. Therefore, as a result of reduced input to the DC-DC converter, it is advantageous for mounting vibration requirements, and it becomes possible to simplify the structure.

The DC-DC converter mounting structure according to the present disclosure may be [2] “the DC-DC converter mounting structure according to [1] above, wherein the electrified vehicle has a plurality of the cross members, and the holding member, in a state of holding the DC-DC converter, is disposed below the cross member that is located rearward of the front wheels of the electrified vehicle and is the most forward among the plurality of the cross members.” In this case, the DC-DC converter can be disposed below the cross member that is located rearward of the front wheels of the electrified vehicle and is the most forward. Therefore, since the distance between the electrical component disposed at the front part of the electrified vehicle and the DC-DC converter is shortened, the connection between the electrical component and the DC-DC converter is facilitated.

The DC-DC converter mounting structure according to the present disclosure may be [3] “the DC-DC converter mounting structure according to [1] or [2] above, including a plurality of the holding members, wherein the plurality of the holding members, wherein each holds the DC-DC converter, are stacked on each other in a vertical direction and integrated, and are disposed below the cross member.” In this case, since each of the plurality of holding members holds a DC-DC converter, a plurality of DC-DC converters can be mounted below the cross member. In addition, by stacking the plurality of DC-DC converters in the vertical direction, the space below the cross member can be utilized more effectively.

The DC-DC converter mounting structure according to the present disclosure may be [4] “the DC-DC converter mounting structure according to [3] above, wherein one of the plurality of the holding members that is located at a lowermost position includes a first holding portion that has a U-shape open upward when viewed from a longitudinal direction of the electrified vehicle and holds one of the DC-DC converters, and wherein another of the plurality of the holding members that is located at an uppermost position includes a second holding portion that has a U-shape open downward when viewed from the longitudinal direction and holds another of the DC-DC converters.” In this case, a plurality of DC-DC converters can be held more efficiently in a space defined by the U-shaped first holding portion of the holding member located at the lowermost position and the U-shaped second holding portion of the holding member located at the uppermost position.

The DC-DC converter mounting structure according to the present disclosure may be [5] “the DC-DC converter mounting structure according to any one of [1] to [4] above, wherein the bracket fixes the holding member to the side rails and the cross member.” In this case, the fixing of the holding member is strengthened.

According to the present disclosure, it is possible to provide a DC-DC converter mounting structure that can mount a DC-DC converter in an electrified vehicle while effectively utilizing space, and whose structure can be simplified.

### BRIEF DESCRIPTION OF THE DRAWINGS

FIG. 1 is a schematic plan view illustrating a part of a vehicle including a DC-DC converter mounting structure according to the present embodiment.

FIG. 2 is a schematic perspective view illustrating an enlarged view of a part of FIG. 1.

FIG. 3 is a perspective view illustrating the DC-DC converter and the DC-DC converter mounting structure illustrated in FIG. 2.

FIG. 4 is a perspective view illustrating the DC-DC converter mounting structure illustrated in FIG. 3.

### DETAILED DESCRIPTION

Hereinafter, a DC-DC converter mounting structure according to an embodiment will be described with reference to the drawings. In the description of each drawing, the same or corresponding elements are denoted by the same reference numerals, and redundant description may be omitted. In addition, each drawing may illustrate an orthogonal coordinate system defined by an X-axis, a Y-axis that intersects the X-axis, and a Z-axis that intersects the X-axis and the Y-axis.

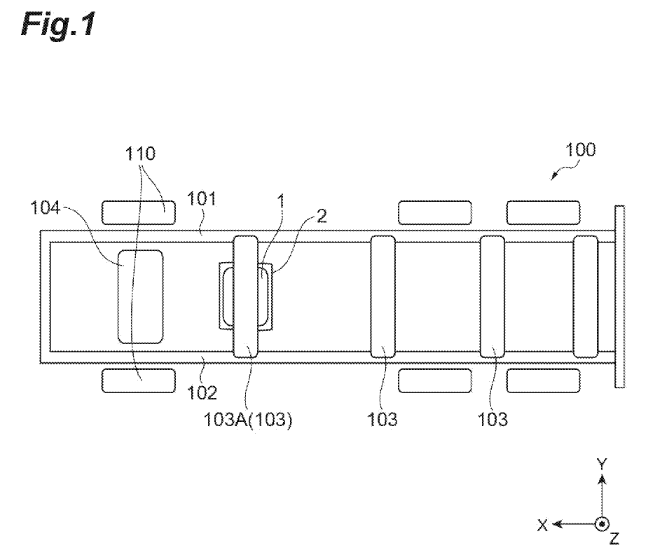

FIG. 1 is a schematic plan view illustrating a part of a vehicle including a DC-DC converter mounting structure according to the present embodiment. The vehicle 100 is, for example, a large vehicle such as a truck, a freight vehicle, or a bus vehicle. The vehicle 100 is also, for example, an electrified vehicle. The electrified vehicle is, for example, a hybrid electric vehicle (HEV), a plug-in hybrid electric vehicle (PHEV), a fuel cell electric vehicle (FCEV), a battery electric vehicle (BEV), or the like. As an example, the X direction indicates the longitudinal direction of the vehicle 100, the Y direction indicates the vehicle width direction of the vehicle 100, and the Z direction indicates the vertical direction.

The vehicle 100 includes a DC-DC converter 1, a DC-DC converter mounting structure 2, a pair of side rails 101, 102, a plurality of cross members 103, and an electrical component 104. The pair of side rails 101, 102 are arranged while being spaced apart from each other along the Y direction, and extend along the X direction. The plurality of cross members 103 are arranged while being spaced apart from each other along the X direction, and are provided so as to be bridged between the pair of side rails 101, 102. The electrical component 104 is any component that can be electrically connected to the DC-DC converter, and is, for example, a fuel cell (FC stack), a battery, or the like. The electrical component 104 is disposed at a front part of the vehicle 100.

The DC-DC converter 1 has a function of receiving an input of DC power from the electrical component 104 or another electrical component, performing voltage conversion of the DC power, and outputting it to another electrical component. As will be described later, the DC-DC converter 1 is mounted on a lower part of the cross member 103 by the DC-DC converter mounting structure 2. More specifically, the DC-DC converter 1 is mounted below the cross member 103A, which is located rearward of the front wheels 110 and closest to the front wheels 110 among the plurality of cross members 103.

The space below the cross member 103A is a space where a transmission, a propeller shaft, or the like connected to an internal combustion engine may be disposed if the vehicle 100 were driven by an internal combustion engine. Therefore, when the vehicle 100 is an electrified vehicle and is not provided with a transmission or a propeller shaft, the space below the cross member 103A is relatively large and can be effectively utilized for mounting the DC-DC converter 1. Note that even when the vehicle 100 is an electrified vehicle and is provided with a transmission and a propeller shaft, it is conceivable to mount the DC-DC converter 1 in the space in order to effectively utilize the space below the cross member 103A or other cross members 103.

As described above, the DC-DC converter mounting structure 2 is for mounting the DC-DC converter 1 below the cross member 103 (in the present embodiment, the cross member 103A). Subsequently, the DC-DC converter mounting structure 2 will be described more specifically.

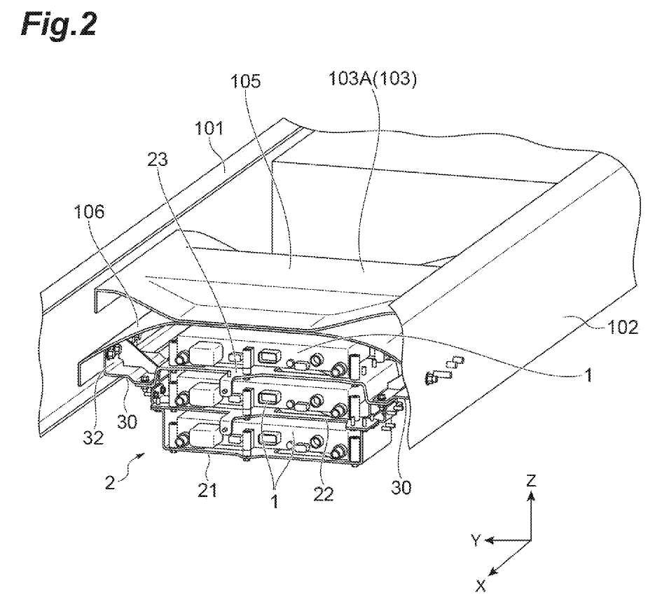

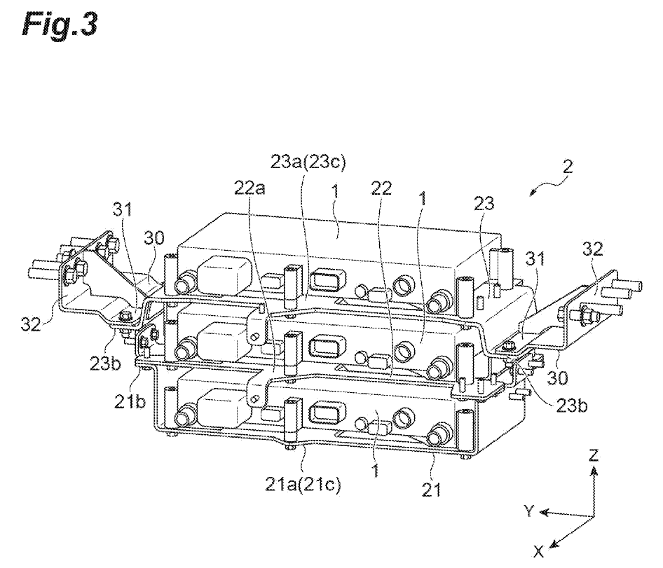

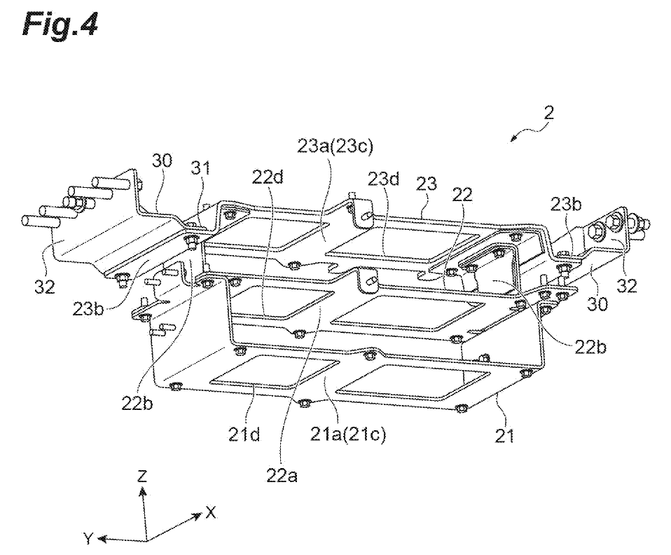

FIG. 2 is a schematic perspective view illustrating an enlarged view of a part of FIGS. 1, 3 is a perspective view illustrating the DC-DC converter and the DC-DC converter mounting structure illustrated in FIGS. 2 and 4 is a perspective view illustrating the DC-DC converter mounting structure illustrated in FIG. 3. As illustrated in FIGS. 2 to 4, the DC-DC converter mounting structure 2 includes a plurality of (three in this case) holding members 21 to 23 and a pair of brackets 30.

The holding members 21 to 23 are each disposed below the cross member 103A in a state of holding the DC-DC converter 1. Therefore, in the present embodiment, the vehicle 100 includes a plurality of (the same number as the holding members, three in this case) DC-DC converters 1. As described above, the brackets 30 fix the holding members 21 to 23 to the side rails 101, 102 and the cross member 103A.

The holding members 21 to 23 are stacked in this order from bottom to top in the Z direction. Therefore, the holding member 21 (one holding member) is located at the lowermost position in the Z direction among the holding members 21 to 23, and the holding member 23 (another holding member) is located at the uppermost position in the Z direction among the holding members 21 to 23. The holding member 22 is interposed between the holding member 21 and the holding member 23 in the Z direction.

The holding member 21 includes a holding portion (first holding portion) 21a and a pair of flange portions 21b. The holding portion 21a has a U-shape that is open upward when viewed from the X direction, and holds one DC-DC converter 1 on its bottom portion 21c. A plurality of (two in this case) openings 21d arranged along the Y direction are formed in the bottom portion 21c. The pair of flange portions 21b are provided so as to protrude outward in the Y direction with respect to both end portions of the holding portion 21a in the Y direction.

The holding member 23 includes a holding portion (second holding portion) 23a and a pair of flange portions 23b. The holding portion 23a has a U-shape that is open downward when viewed from the X direction, and holds another DC-DC converter 1 on its bottom portion 23c (on a surface of the bottom portion 23c facing upward). A plurality of (two in this case) openings 23d arranged along the Y direction are formed in the bottom portion 23c. The pair of flange portions 23b are provided so as to protrude outward in the Y direction with respect to both end portions of the holding portion 23a in the Y direction.

The holding member 22 includes a holding portion 22a and a pair of leg portions 22b. The holding portion 22a has a flat plate shape and holds yet another DC-DC converter 1 on its surface facing upward. A plurality of (two in this case) openings 22d arranged along the Y direction are formed in the holding portion 22a. The pair of leg portions 22b are erected at both ends of the holding portion 22a in the Y direction and extend upward to reach the holding portion 23a. The leg portions 22b, by being fixed to the holding portion 22a and the holding portion 23a, fix the holding member 22 and the holding member 23 to each other while maintaining a space between the holding portion 22a and the holding portion 23a.

In addition, the flange portions 21b of the holding member 21 are fixed in an overlapping manner to both end portions of the holding portion 22a in the Y direction, thereby fixing the holding member 21 and the holding member 22 to each other. As a result, the holding members 21 to 23 are fixed to each other and integrated. In that state, the DC-DC converters 1 are held between the holding member 21 and the holding member 22, between the holding member 22 and the holding member 23, and on the holding member 23, respectively, and are thereby stacked along the Z direction. Note that the bottom portion 21c of the holding portion 21a, the holding portion 22a, and the bottom portion 23c of the holding portion 23a extend along the X direction and the Y direction, and are substantially parallel to each other.

The bracket 30 includes a first fixing portion 31 that extends along the X direction and the Y direction and overlaps with each of the flange portions 23b of the holding member 23, and a second fixing portion 32 that extends along the X direction and the Z direction and overlaps with each of the side rails 101, 102. The bracket 30 fixes the holding members 21 to 23 to the side rails 101, 102 by being fixed to the flange portions 23b of the holding member 23 at the first fixing portion 31 and being fixed to the side rails 101, 102 at the second fixing portion 32.

Note that in the present embodiment, the cross member 103A includes a first portion 105 that is bridged between the pair of side rails 101, 102, and a second portion 106 that is stacked below the first portion 105 and is bridged between the pair of side rails 101, 102. The first portion 105 and the second portion 106 are in contact with each other (e.g., joined) at a central portion of the cross member 103A in the Y direction, and are spaced apart from each other in the Z direction at both end portions of the cross member 103A in the Y direction, and are fixed at different Z-direction positions of the side rails 101, 102.

Then, the second fixing portion 32 of the bracket 30 is fixed to a portion of the second portion 106 where the second portion is fixed with the side rails 101, 102 (for example, the bracket 30 and the cross member 103A are fastened together to the side rails 101, 102). As a result, the bracket 30 fixes the holding members 21 to 23 to both the side rails 101, 102 and the cross member 103A.

As described above, in the DC-DC converter mounting structure 2 according to the present embodiment, the holding members 21 to 23 in a state of holding the DC-DC converter 1 are disposed below the cross member 103, and the holding members 21 to 23 are fixed to at least the side rails 101, 102 by the bracket 30. This allows the DC-DC converter 1 to be mounted below the cross member 103.

Thus, according to the DC-DC converter mounting structure 2, the DC-DC converter 1 can be mounted by effectively utilizing the space below the cross member 103. In addition, in the DC-DC converter mounting structure 2, the DC-DC converter 1 is disposed at an installation portion of the cross member 103 on the pair of side rails 101, 102, which have relatively high rigidity. Therefore, as a result of reduced input to the DC-DC converter 1, it is advantageous for mounting vibration requirements, and it becomes possible to simplify the structure.

In addition, in the DC-DC converter mounting structure 2 according to the present embodiment, the vehicle 100 has a plurality of cross members 103, and the holding members 21 to 23, in a state of holding the DC-DC converter 1, are disposed below the cross member 103A that is located rearward of the front wheels 110 of the vehicle 100 and is the most forward among the plurality of cross members 103. For this reason, the DC-DC converter 1 can be disposed below the cross member 103A that is located rearward of the front wheels of the vehicle 100 and is the most forward. Therefore, since the distance between the electrical component 104 disposed at the front part of the vehicle 100 and the DC-DC converter 1 is shortened, the connection between the electrical component 104 and the DC-DC converter 1 is facilitated.

In addition, the DC-DC converter mounting structure 2 according to the present embodiment includes a plurality of holding members 21 to 23, and the plurality of holding members 21 to 23, in a state where each holds the DC-DC converter 1, are stacked on each other in a vertical direction (Z direction) and integrated, and are disposed below the cross member 103. Thus, in the DC-DC converter mounting structure 2, since each of the plurality of holding members 21 to 23 holds a DC-DC converter 1, a plurality of DC-DC converters 1 can be mounted below the cross member 103. In addition, by stacking the plurality of DC-DC converters 1 in the vertical direction, the space below the cross member 103 can be utilized more effectively.

In addition, in the DC-DC converter mounting structure 2 according to the present embodiment, the holding member 21, which is located at the lowermost position among the plurality of holding members 21 to 23, includes the holding portion 21a that has a U-shape open upward when viewed from the longitudinal direction (X direction) and holds one DC-DC converter 1. Then, the holding member 23, which is located at the uppermost position among the plurality of holding members 21 to 23, includes the holding portion 23a that has a U-shape open downward when viewed from the X direction and holds another DC-DC converter 1. For this reason, a plurality of DC-DC converters 1 can be held more efficiently in a space defined by the U-shaped holding portion 21a of the holding member 21 and the U-shaped holding portion 23a of the holding member 23.

Furthermore, in the DC-DC converter mounting structure 2 according to the present embodiment, the bracket 30 fixes the holding members 21 to 23 to the side rails 101, 102 and the cross member 103. For this reason, the holding members 21 to 23 are fixed more securely.

The above embodiment has described one aspect of the present disclosure. Therefore, the present disclosure is not limited to the DC-DC converter mounting structure 2 according to the above embodiment, and the DC-DC converter mounting structure 2 may be arbitrarily modified.

For example, in the above embodiment, a case has been described where the bracket 30 fixes the holding members 21 to 23 to both the side rails 101, 102 and the cross member 103. However, the bracket 30 only needs to fix the holding members 21 to 23 to at least one of the side rails 101, 102 and the cross member 103.

In addition, in the above embodiment, a case was illustrated where the DC-DC converter mounting structure 2 includes a plurality of holding members 21 to 23. However, the DC-DC converter mounting structure 2 may have only one holding member, and in that case, the number of DC-DC converters 1 may also be one.

Furthermore, the shape of the holding portions 21a, 23a of the holding members 21, 23 when viewed from the X direction is not limited to a U-shape and may be any shape.

What is claimed is:

1. A DC-DC converter mounting structure for mounting a DC-DC converter below a cross member in an electrified vehicle having a pair of side rails arranged in a vehicle width direction and the cross member provided to be bridged between the pair of side rails, the DC-DC converter mounting structure comprising:
a holding member that is disposed below the cross member in a state of holding the DC-DC converter; and
a bracket for fixing the holding member to the side rails and/or the cross member.

2. The DC-DC converter mounting structure according to claim 1, wherein the electrified vehicle has a plurality of the cross members, and
the holding member, in a state of holding the DC-DC converter, is disposed below the cross member that is located rearward of front wheels of the electrified vehicle and is the most forward among the plurality of the cross members.

3. The DC-DC converter mounting structure according to claim 1, comprising a plurality of the holding members,
wherein the plurality of the holding members, in a state where each holds the DC-DC converter, are stacked on each other in a vertical direction and integrated, and are disposed below the cross member.

4. The DC-DC converter mounting structure according to claim 3, wherein one of the plurality of the holding members that is located at a lowermost position includes a first holding portion that has a U-shape open upward when viewed from a longitudinal direction of the electrified vehicle and holds one of the DC-DC converters, and
wherein another of the plurality of the holding members that is located at an uppermost position includes a second holding portion that has a U-shape open downward when viewed from the longitudinal direction and holds another of the DC-DC converters.

5. The DC-DC converter mounting structure according to claim 1, wherein the bracket fixes the holding member to the side rails and the cross member.
